(19) United States
(12) Patent Application Publication
(10) Pub. No.: US 2009/0131549 A1
(43) Pub. Date: May 21, 2009

(54) PROCESS FOR PREPARING POLYVINYLPYRROLIDONES BY SPRAY POLYMERIZATION

(75) Inventors: Dennis Losch, Altrip (DE); Ralf Widmaier, Ludwigshafen (DE); Volker Seidl, Mannheim (DE); Hans-Ulrich Moritz, Bendestorf (DE); Karim Asif, Mannheim (DE); Silke Biedasek, Mannheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/271,438

(22) Filed: Nov. 14, 2008

(30) Foreign Application Priority Data
Nov. 16, 2007 (EP) 07120905.0

(51) Int. Cl. C08F 26/10

(52) U.S. Cl. 522/167; 526/264; 526/229; 526/227; 526/230; 526/234; 526/218.1

(57) ABSTRACT

A process for preparing polyvinylpyrrolidones by free-radically initiated polymerization in the presence of an initiator found, which comprises performing the polymerization as a spray or droplet polymerization.

The present invention relates to a process for preparing polyvinylpyrrolidones by spray polymerization of a monomer solution.

Further embodiments of the present invention can be inferred from the claims, the description and the examples. It is self-evident that the features of the inventive subject matter which have been mentioned above and those which are yet to be mentioned below can be used not only in the combination specified in each case, but also in other combinations, without leaving the scope of the invention.

Polyvinylpyrrolidones are typically prepared by free-radical polymerization in solution. To prepare polymers with relatively low molar masses, isopropanol is usually used as the solvent, while relatively high molecular weight polymers are usually polymerized in water. The workup to the powders is generally effected by spray-drying.

However, the spray-drying is complicated by the fact that polyvinylpyrrolidone solutions tend to string, which is why the solids content of the polymer solution has to be kept relatively low. As a result, however, the energy consumption in the spray-drying increases, which is unfavorable from an ecological and economic point of view.

An additional factor is that polyvinylpyrrolidones, at relatively high molar masses of usually greater than 100 000 g/mol (M_{w}), owing to viscosity effects, can be spray-dried at all only at low solids content. The limitation by the viscosity leads to the result that relatively high molecular weight polyvinylpyrrolidones can generally be worked up only by drum drying and other methods, but not by spray-drying.

U.S. Pat. No. 3,644,305 discloses a spray polymerization process with which low molecular weight polymers can be prepared. The polymerization is carried out at elevated pressure.

Spray polymerization processes are also known from WO 2006/079631, WO 2006/114404 or WO 2006/120232.

According to the patent application WO-A-96/40427, the spray polymerization is carried out in such a way that monomer solutions are sprayed into a heated, essentially static atmosphere.

It was therefore an object of the present invention to provide an improved process for preparing polyvinylpyrrolidones.

Accordingly, a process has been found for preparing polyvinylpyrrolidones by free-radically initiated polymerization, which comprises performing the polymerization as a spray or droplet polymerization.

According to the invention, spray or droplet polymerization means that a solution comprising monomers and initiators in a solvent is sprayed with the aid of suitable apparatus, such as nozzles, or is shaped to droplets with suitable apparatus, the process being conducted in such a way that the polymerization sets in after the spraying or droplet formation.

According to the invention, polyvinylpyrrolidones refer to homo- and copolymers of N-vinylpyrrolidone, Suitable comonomers are vinyl acetate, vinyl propionate, vinyl laurate, further nitrogen-heterocyclic N-vinyl monomers such as N-vinylimidazole, 3,4 or 5-methyl-quaternized N-vinylimidazole, or N-vinylcaprolactam.

The polymerization reaction can be carried out in the presence of an inert carrier gas, “inert” meaning that the carrier gas cannot react with the constituents of the monomer solution. The inert carrier gas is preferably nitrogen. The oxygen content of the inert carrier gas is advantageously below 1% by volume, preferably below 0.5% by volume, more preferably below 0.1% by volume.

The inert carrier gas can be conducted through the reaction chamber in cocurrent or in countercurrent to the free-falling droplets of the monomer solution, preferably in cocurrent. After one pass, the carrier gas is preferably recycled at least partly into the reaction chamber as cycle gas, preferably to an extent of at least 50%, more preferably to an extent of at least 75%. Typically, a portion of the carrier gas is discharged after each pass, preferably at least 10%.

The gas velocity is preferably adjusted such that the flow in the reactor is directed, for example no convection eddies opposed to the general flow direction are present, and is, for example, from 0.02 to 1.5 m/s, preferably from 0.05 to 0.4 m/s.

The reaction temperature is preferably from 70 to 250° C., more preferably from 80 to 190° C., most preferably from 90 to 160° C.

The concentration of the monomers a) in the monomer solution is typically from 2 to 80% by weight, preferably from 5 to 70% by weight, more preferably from 10 to 60% by weight.

The monomers are polymerized with one another in aqueous solution in the presence of initiators.

The initiators are used in customary amounts, for example in amounts of from 0.001 to 5% by weight, preferably from 0.01 to 3% by weight, based on the monomers to be polymerized.

The initiators used may be all compounds which decompose to free radicals under the polymerization conditions, for example peroxides, hydroperoxides, hydrogen peroxide, persulfates, azo compounds and the so-called redox initiators. Preference is given to the use of readily water-soluble initiators, but it may also be advisable from case to case to use only moderately water-soluble compounds, in which case it is additionally also possible to use methanol, ethanol or isopropanol as solubilizers. In some cases, it is advantageous to use mixtures of different initiators, for example mixtures of hydrogen peroxide and sodium peroxodisulfate or potassium peroxodisulfate. Mixtures of hydrogen peroxide and sodium peroxodisulfate can be used in any desired ratio.

Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl pemeohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl perester, cumyl peroxyneodecanoate, tert-butyl per-3,5,5-trimethylhexanoate, acetylcyclohexylsulfonyl peroxide, dilauryl peroxide, dibenzoyl peroxide and tert-amyl perneodecanoate.

Preferred initiators are azo compounds, for example 2,2′-azobis-isobutyronitrile, 2,2′-azobis(2,4-dimethylvaleronitrile) and 2,2′-azobis(4-methoxy-2,4-dimethylvaleronitrile), especially water-soluble azo initiators, for example 2,2′-azobis {2-[1-(2-hydroxyethyl)-2-imidazolin-2-yl]propane}dihydrochloride, 2,2′-azobis-(2-amidinopropane) dihydrochloride, 2,2′-azobis[2-(2-imidazolin-2-yl)propane]dihydrochloride and 2,2′-azobis[2-(S-methyl-2-imidazolin-2-yl)propane]dihydrochloride. Very particular preference is given to 2,2′-azobis[2-(2-imidazolin-2-yl)propane]dihydrochloride and 2,2′-azobis[2-(5-methyl-2-imidazolin-2-yl)propane]dihydrochloride and 2,2′-azobis(2-methylbutyronitrile).

Further preferred initiators are also redox initiators. The redox initiators comprise, as the oxidizing component, at least one of the above-specified peroxo compounds, and, as the reducing component, for example, ascorbic acid, glucose, sorbose, ammonium hydrogensulfite, sulfite, thiosulfate, hyposulfite, pyrosulfite or sulfide or alkali metal hydrogensulfite, sulfite, thiosulfate, hyposulfite, pyrosulfite or sulfide, or sodium hydroxymethylsulfoxylate. Preference is given to using, as the reducing component of the redox catalyst, ascorbic acid or sodium pyrosulfite. Based on the amount of monomers used in the polymerization, for example, from 1×10⁻⁵ to 1 mol % of the reducing component of the redox catalyst is used.

Particularly preferred initiators are azo initiators such as 2,2′-azobis[2-(2-imidazolin-2-yl)propane]dihydrochloride and 2,2′-azobis[2-(5-methyl-2-imidazolin-2-yl)propane]dihydrochloride.

Particular preference is also given to photoinitiators such as 2-hydroxy-2-methylpropiophenone and 1-[4-(2-hydroxyethoxy)phenyl]-2-hydroxy-2-methyl-1-propan-1-one, redox initiators such as sodium persulfate/hydroxymethylsulfinic acid, ammonium peroxodisulfate/hydroxymethylsulfinic acid, hydrogen peroxide/hydroxymethylsulfinic acid, sodium persulfate/ascorbic acid, ammonium peroxodisulfate/ascorbic acid and hydrogen peroxide/ascorbic acid, photoinitiators such as 1-[4-(2-hydroxyethoxy)phenyl]-2-hydroxy-2-methyl-1-propan-1-one, and mixtures thereof.

The polymerization is more preferably triggered by the action of high-energy radiation, typically using so-called photoinitiators as the initiator. These may, for example, be so-called alpha-splitters, H-abstracting systems or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and derivatives thereof, azo compounds such as the above-mentioned free-radical formers, substituted hexaarylbisimidazoles or acylphosphine oxides, especially 2-hydroxy-2-methylpropiophenone (Darocure® 1173). Examples of azides are 2-(N,N-dimethylamino)ethyl 4-azidocinnamate, 2-N,N-dimethylamino)ethyl 4-azidonaphthyl ketone, 2-(N,N-dimethylamino)ethyl 4-azidobenzoate, 5-azido-1-naphthyl 2′-(N,N-dimethylamino)ethyl sulfone, N-(4-sulfonylazidophenyl)maleinimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methylcyclohexanone.

The reaction is preferably carried out in apparatus which is also suitable for spray-drying. Such reactors are described, for example, in K. Masters, Spray Drying Handbook, 5th Edition, Longman, 1991, pages 23 to 66.

The spraying or dropletization can be effected by means of all suitable apparatus, such as nozzles, dropletizer plates, or by means of laminar jet decomposition.

In the process according to the invention, it is possible to use one or more spray nozzles. The spray nozzles which can be used are not subject to any restriction. The liquid to be sprayed can be fed under pressure to such nozzles. The liquid to be sprayed can be atomized by decompressing it in the nozzle bore on attainment of a particular minimum velocity. In addition, it is also possible to use one-substance nozzles, for example slot nozzles or swirl chambers (full-cone nozzles) (for example from Düsen-Schlick GmbH, Germany, or from Spraying Systems Deutschland GmbH, Germany) for the inventive purpose.

Preference is given in accordance with the invention to full-cone nozzles. Among these, preference is given to those having an opening angle of the spray cone of from 60 to 180°. Particular preference is given to opening angles of from 90 to 120°. According to the invention, the mean droplet diameter which is established in the course of spraying is typically less than 1000 μm, preferably less than 200 μm, preferentially less than 100 μm, and typically greater than 10 μm, preferably greater than 20 μm, preferentially greater than 50 μm, and can be determined by customary methods, such as light scattering, or with reference to the characteristics obtainable from the nozzle manufacturers. The throughput per spray nozzle is appropriately from 0.1 to 10 m³/h, frequently from 0.5 to 5 m³/h.

The droplet diameter which is established in the course of spraying is appropriately from 10 to 1000 μm, preferably from 10 to 500 μm, more preferably from 10 to 150 μm, most preferably from 10 to 45 μm.

The reaction can also be performed in apparatus in which the monomer solution can fall freely in the form of monodisperse droplets. Suitable apparatus for this purpose is that as described, for example, in the patent U.S. Pat. No. 5,269,980, column 3, lines 25 to 32.

Dropletization by laminar jet decomposition, as described in Rev. Sci. Instr., volume 38 (1966), pages 502 to 506, is likewise possible.

Dropletization is preferred over spraying, especially when photoinitiators are used.

When, in contrast, high throughputs of monomer solution are desired, spraying of the monomer solution into the reaction chamber is preferred.

The reaction chamber of the polymerization reactor can be carried out under elevated pressure or under reduced pressure; a reduced pressure of up to 100 mbar relative to ambient pressure is preferred.

The polymerization rate and the drying rate typically have different temperature dependences. This can mean, for example, that the sprayed droplets dry before the desired conversion has been attained. It is therefore advantageous to influence the reaction rate and the drying rate separately.

The drying rate can be influenced via the water vapor content of the inert gas. The water vapor content of the inert gas is generally up to 90% by volume, preferably up to 50% by volume.

The polymerization rate can be established through the type and amount of the initiator system used.

To control the polymerization rate, it is advantageous to use azo compounds or redox initiators as initiators. The onset behavior of the polymerization can be controlled better with azo compounds or redox initiators via selection of the initiator, initiator concentration and reaction temperature than, for example, with pure peroxide initiators.

Photoinitiators are particularly advantageous. When photoinitiators are used, the drying rate can be adjusted to the desired value via the temperature, without simultaneously significantly influencing the free radical formation.

The carrier gas is appropriately preheated upstream of the reactor to the reaction temperature of from 70 to 250° C., preferably from 80 to 190° C., more preferably from 90 to 160° C.

The reaction offgas, i.e. the carrier gas leaving the reaction chamber, can, for example, be cooled in a heat exchanger. This condenses water and unconverted monomer. Thereafter, the reaction offgas can at least partly be reheated and recycled into the reactor as cycle gas. Preference is given to cooling the cycle gas such that the cooled cycle gas has the proportion of water vapor desired for the reaction. A portion of the reaction offgas can be discharged and replaced by fresh carrier gas, in which case unconverted monomers present in the reaction offgas can be removed and recycled.

Particular preference is given to thermal integration, i.e. some of the waste heat in the cooling of the offgas is used to heat up the cycle gas.

The reactors can be trace heated. The trace heating is adjusted such that the wall temperature is at least 5° C. above the internal reactor temperature, and condensation on the reactor walls is reliably prevented.

The reaction product can be withdrawn from the reactor in a customary manner, preferably at the bottom via a conveying screw, and if appropriate dried down to the desired residual moisture content and to the desired residual monomer content, for example in an integrated fluidized bed.

Spray polymerization allowed the process steps of polymerization and drying to be combined. In addition, the particle size was adjustable within certain limits through suitable process control. In this way, the disadvantages of conventional workup of polymer solutions of polyvinylpyrrolidones can be avoided.

The resulting particle sizes are in the range from 10 to 400 μm, preferably from 50 to 200 μm. The K values according to Fikentscher (measured in 20% by weight aqueous solution) may be from 10 to 100, preferably from 10 to 90, especially from 10 to 60. The polymers may have a molecular weight distribution M_{w} of from 2000 to 1.8 million, preferably from 2000 to 1 million, especially from 2000 to 400 000 g/mol.

### EXAMPLES

### General Method 1

The polymers were prepared in an apparatus consisting of two zones. The upper zone consisted of a column under nitrogen gas (height 2 m, diameter 35 cm), in which 6 UV lamps (iron-doped Hg lamp, power in each case 6 kW) were arranged in alternation. At the upper end of this zone, a perforated plate with 32 holes (diameter 200 μm) was mounted for dropletization. The throughput of monomer solution through the perforated plate and the composition of the monomer solution can be taken from the particular examples.

To this was attached, in the downward direction, as the second zone, a larger column with a height of 8 m and a diameter of 2 m, which was flowed through from the top downward with nitrogen gas at a velocity of the gas stream of 0.1 m/s and a gas inlet temperature of 150° C.

White powders with the mean particle sizes in [μm] specified below were obtained. The powders were dissolvable in water to form clear solutions.

The following abbreviations are used below:

NVP: N-vinylpyrrolidone

IN: alpha-hydroxy ketone initiator

### Example 1

| | | Conc. of reactants | |
|---|---|---|---|
| Reactants | Feed rate [l/h] | in feed [% by wt.] | Product properties |
| NVP | 7.0 | 40.5 | K value 19 [20% |
| Demineralized | 10.0 | 59.3 | strength by weight |
| water | | | in H2O]; 350 μm |
| IN | 0.2 | 0.2 | |

### Example 2

| | | Conc. of reactants | |
|---|---|---|---|
| Reactants | Feed rate [l/h] | in feed [% by wt.] | Product properties |
| NVP | 4.5 | 30.6 | K value 17 [20% |
| Demineralized | 10.0 | 69.3 | strength by weight |
| water | | | in H2O]; 340 μm |
| IN | 0.2 | 0.1 | |

### Example 3

| | | Conc. of reactants | |
|---|---|---|---|
| Reactants | Feed rate [l/h] | in feed [% by wt.] | Product properties |
| NVP | 7.0 | 40.8 | K value 20 [20% |
| Demineralized | 10.0 | 59.1 | strength by weight |
| water | | | in H2O]; 350 μm |
| IN | 0.2 | 0.1 | |

### General Method 2

The polymers were prepared in a heated spray tower inertized with nitrogen (height 15 m, width 2 m), and the nitrogen gas stream was conducted from the top downward in cocurrent at a velocity of 0.1 nm/s. The dropletization was effected by means of a dropletizer plate, and the bores in the dropletizer plate had a diameter of 100 μm. The temperature in the spray tower was 180° C.

The free-radical initiator used was 2,2′-azobis[2-(2-imidazolin-2-yl)propane]dihydro-chloride,

The polymers were obtained as white powder. The K value was measured on a 20% by weight solution.

### Composition of the Dropletized Solutions

### Example 1

5000 g of DM water (DM: demineralized)

4600 g of N-vinylpyrrolidone (NVP)

400 g of initiator

### Example 2

5200 g of DM water

4600 g of NVP

200 g of initiator

### Example 3

5300 g of water

4600 g of NVP

11 g of initiator

| Example No. | Particle diameter [μm] | K value | Mₙ/M_{w} |
|---|---|---|---|
| 1 | 180 | 12 | 1.07 |
| 2 | 190 | 14 | 1.10 |
| 3 | 190 | 16 | 1.15 |

1. A process for preparing polyvinylpyrrolidones by free-radically initiated polymerization in the presence of an initiator, which comprises performing the polymerization as a spray or droplet polymerization.

2. The process according to claim 1, wherein the initiators used are organic and inorganic peroxides, hydroperoxides, persulfates, azo compounds, photoinitiators or redox initiators.

3. The process according to claim 1, wherein the initiators used are azo initiators.

4. The process according to claim 1, wherein the initiators used are photoinitiators.

5. The process according to claim 1, wherein the polymerization is performed in aqueous solution.

6. The process according to claim 1, wherein the polymerization temperature is from 70 to 250° C.

7. The process according to claim 1, wherein the droplets are formed in an inert gas stream.

8. The process according to claim 1, wherein the spraying or droplet formation and the polymerization are effected in a spray tower.
